(19) United States
(12) Patent Application Publication
(10) Pub. No.: US 2013/0323522 A1
(43) Pub. Date: Dec. 5, 2013

(54) CAST SUPERALLOY PRESSURE CONTAINMENT VESSEL

(71) Applicants: Daniel Frederick Purdy, Schenectady, NY (US); Robin Carl Schwant, Pattersonville, NY (US)

(72) Inventors: Daniel Frederick Purdy, Schenectady, NY (US); Robin Carl Schwant, Pattersonville, NY (US)

(73) Assignee: GENERAL ELECTRIC COMPANY, Schenectady, NY (US)

(21) Appl. No.: 13/489,047

(22) Filed: Jun. 5, 2012

(51) Int. Cl. B32B 1/02

(52) U.S. Cl. 428/544

(57) ABSTRACT

A large volume, cast superalloy pressure containment vessel is disclosed. The vessel includes a hollow body portion having a volume of at least about 4 cubic feet and a substantially porosity-free cast microstructure. The containment vessel configured for operation at an operating temperature of at least about 1,200° F. and an operating pressure of at least about 1,500 psi. A large volume, cast superalloy article is also disclosed. The article has a volume of at least about 4 cubic feet and a substantially porosity-free cast microstructure, the article configured for operation at an operating temperature of at least about 1,400° F.

### FEDERAL RESEARCH STATEMENT

This invention was made with Government support under Contract No. DE-FE-0000234, awarded by the US Department of Energy (DOE). The Government has certain rights in this invention.

### BACKGROUND OF THE INVENTION

The formation of large articles for use in various applications, including various machines, which require that the articles be used at high operating temperatures and pressures is particularly challenging. For example, large components are employed in industrial turbines, particularly steam turbines, which are very large dimensionally, including length, width, height and wall section thickness, and with regard to the volume of material employed to make them. These components are generally formed from various forged steel alloy preforms. Frequently, the sizes and shapes of these components, which may be substantially hollow bodies, require that significant portions of the forged preforms be removed by machining or other forming methods. The fact that fabrication requires significant removal of material has limited the materials used in these high operating temperature and pressure articles and applications to materials that can readily be machined or otherwise fabricated to form these large articles. While many grades of steel are useful for these purposes, their material properties have limited the operating temperature and pressure ranges over which they may be employed, thereby constraining advancements in the machines, such as various turbines, in which they are used. Further, high temperature materials, such as superalloys, have not been employed to make such large articles because they have required that the large articles be fabricated as an assembly of smaller subcomponents, which requires forming of the subcomponents, such as by forging, followed by joining of the subcomponents, such as by welding, which is very difficult to do when the sizes, particularly when the section thicknesses, of the subcomponents are also large.

Therefore, it would be very desirable to provide large articles, such as various large turbine components, which may be formed from high temperature materials, such as superalloys.

### BRIEF DESCRIPTION OF THE INVENTION

In an exemplary embodiment, a large volume, cast superalloy pressure containment vessel is disclosed. The vessel includes a hollow body portion having a volume of at least about 4 cubic feet and a substantially porosity-free cast microstructure. The containment vessel is configured for operation at an operating temperature of at least about 1,200° F. and an operating pressure of at least about 1,500 psi.

In another exemplary embodiment, a large volume, cast superalloy article is disclosed. The article has a volume of at least about 4 cubic feet and a substantially porosity-free cast microstructure. The article is configured for operation at an operating temperature of at least about 1,400° F.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional illustration of an exemplary embodiment of a cast superalloy pressure containment vessel comprising a cast steam turbine shell for a steam turbine, as disclosed herein;

FIG. 2 is a perspective view of a second exemplary embodiment of a cast superalloy pressure containment vessel comprising a steam turbine nozzle box as disclosed herein suitable for use with the steam turbine of FIG. 1;

FIG. 3 is a partial cross-sectional view of the nozzle box shown in FIG. 2;

FIG. 4 is a cross-sectional illustration of a third exemplary embodiment of a cast superalloy pressure containment vessel comprising a steam turbine valve casing as disclosed herein suitable for use with the steam turbine of FIG. 1; and

FIG. 5 is a table of various exemplary embodiments of Ni-based superalloy compositions suitable for use to form the large volume, cast superalloy pressure containment vessels disclosed herein.

The detailed description explains embodiments of the invention, together with advantages and features, by way of example with reference to the drawings.

### DETAILED DESCRIPTION OF THE INVENTION

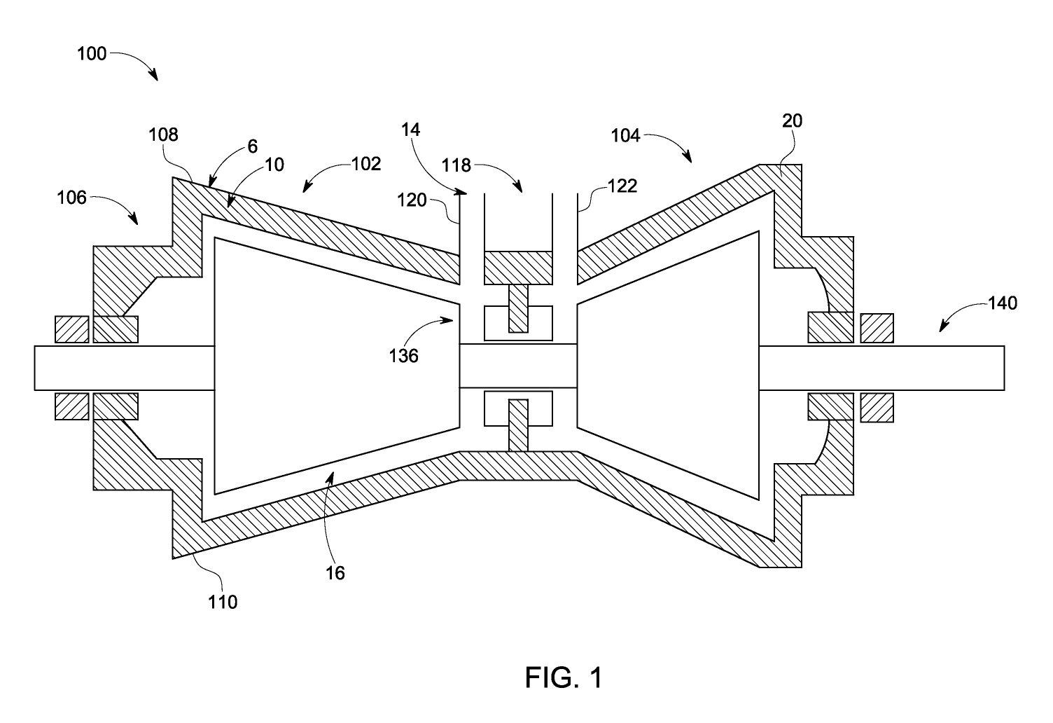

Referring to the figures, and particularly to FIGS. 1-4, a large volume, cast pressure containment vessel 10 is disclosed. In various embodiments, the large volume, cast pressure containment vessel 10 may include various turbine pressure containment vessels, as described herein. The large volume, cast pressure containment vessels 10 are particularly suited for application and use as non-rotating components in various steam turbine configurations, particularly those that are adapted to receive a flow 12 of a high pressure fluid through an inlet 14 and pass the high pressure fluid flow 12 through a hollow body portion 16 to a separate outlet 18, typically with a pressure drop or rise through the pressure containment vessel 10. As such, the vessel must be configured to receive a high absolute pressure, such as about 1,500 psi, and contain the pressure while passing the flow 12 to the outlet 18. The cast pressure containment vessel 10 has a casting volume or a volume of material used to form the casting of at least about 4 cubic feet and a substantially porosity-free cast microstructure 20. The cast pressure containment vessel 10 is formed from a superalloy and is configured for continuous operation at an operating temperature of at least about 1,200° F. and an operating pressure of at least about 1,500 psi. The cast pressure containment vessel 10 will also typically have a large wall section thickness, which in one embodiment includes a wall section thickness of about 3 inches or more, and more particularly about 6 inches or more, and even more particularly very large wall section thicknesses of about 8 inches or more. In one embodiment, the wall section thickness ranges from about 3 inches to about 12 inches, and more particularly about 3 to about 8 inches, and even more particularly about 3 to about 6 inches. In another embodiment, the wall section thickness ranges from about 3 inches to about 12 inches, and more particularly about 6 inches to about 12 inches, and even more particularly about 8 inches to about 12 inches. The superalloy cast pressure containment vessel 10 may include a component 6 for any type of high temperature turbine, including various gas turbines and steam turbines, but is particularly applicable for use in steam turbines due to the scale and size of various steam turbine components that require very large wall section thicknesses, and consequently require very large volume castings. In one embodiment, the cast large wall section superalloy turbine component 10 may include a nozzle box 200. In another embodiment, the cast large wall section superalloy turbine component 10 may include a turbine shell 106. In yet another embodiment, the cast large wall section superalloy turbine component 10 may include a valve casing 300.

These cast large volume superalloy turbine components 10 are improved by virtue of being able to operate at significantly higher temperatures and/or operating pressures than conventional large wall section turbine components that are formed by forging or casting various non-superalloy subcomponents and joining them to form the components. The ability to operate these components at higher temperatures and/or operating pressures will provide improved turbine operating efficiency. Casting provides a producible and affordable method for making these large volume superalloy turbine components 10. The cast large wall section superalloy turbine component 10, including the nozzle box 200, shell 106 and valve casing 300 and potentially other parts, are able to operate at higher temperatures by virtue of being made from more capable materials including precipitation hardened and solution hardened superalloys. These cast large volume superalloy turbine components 10 may be formed using centrifugal casting. Centrifugal casting will enable the casting of these parts from superalloys. Forming these parts from superalloys other than by casting would be extremely difficult and also prohibitively expensive due to their large volumes and section thicknesses. Forging of large section thickness superalloys is difficult and expensive, and forged components would generally require welding of the superalloys, which would also be very difficult and expensive in view of the section thicknesses involved.

Superalloys have been applied in many other turbine applications requiring high strength at elevated temperatures. However, large volume turbine components, particularly large volume steam turbine components, including nozzle boxes, shells and valve casings have never been produced from superalloys for several reasons. Firstly, these components are very large in size, both dimensionally (length, width, height and wall section thickness) and by weight, and generally have a complex hollow shape. Machining a large hollow component, such as a steam turbine nozzle box, shell (inner or outer) and valve casing, from a solid piece of superalloy, such as a forging, is generally cost prohibitive due to the amount and cost of the material that must be removed (the amount of material removed as wastage being as high as 90%), as well as the cost to remove the material by machining or otherwise. In contrast, centrifugal casting may be employed to create a hollow initial shape and also eliminates the need for excessive complex machining of alloys that are known to be difficult to machine due to their superior physical and mechanical properties, including strength, toughness, hardness and the like. Other casting methods can do this but have drawbacks, such as those noted below. Secondly, the large component size and casting volume results in chemical segregation when cast by conventional methods, such as sand casting. Superalloys are prone to suffer from harmful chemical segregation caused by slow solidification rates when a component is very large, either in total volume, such as, for example, when the volume exceeds 4 cubic feet, or when the section thickness is large, as described herein, or casting porosity, or both. Centrifugal casting provides a means to raise the cooling rate significantly beyond that achievable using sand casting, thereby preventing undesirable slow solidification rates and segregation of the alloying elements of the superalloy, particularly the low density alloying elements, including Al and Ti, and heavy metals that provide many of the superior superalloy properties, including Cr, Nb, Ta, Mo. Thirdly, superalloys are prone to oxidation of constituent metals during melting, as well as during casting using conventional methods, such as sand casting, forming undesirable hard, brittle inclusions, such as various oxides, which can significantly degrade toughness and fatigue properties. Centrifugal casting may be used to minimize exposure to air during the casting process and thereby reduce the number and size of the entrapped oxides to an acceptable level. It is noted that the melting processes used to form superalloys, such as electric arc furnaces with argon oxygen decarburization (EAF/AOD) and vacuum induction melting (VIM) are utilized with remelting processes, such as electroslag remelting (ESR) or vacuum arc remelting (VAR), specifically to address segregation, porosity and oxidation that are known to occur in large volume castings of these alloys, such as ingots. Fourthly, it is very difficult to fabricate large volume components from superalloys, particularly those having very large and/or thick wall sections. Fabrication of large volume superalloy components by other methods has generally not been feasible due to the limitations associated with conventional fabrication methods as applied to superalloy compositions. For example, tungsten inert gas (TIG) welding is generally too slow to be suitable for joining of long sections with thick wall sections. Electron beam welding requires a vacuum chamber and existing vacuum chambers are too small to encompass the large steam turbine components described herein, such as a valve casing. Laser welding is generally not able to make welds of sufficient depth to make the large steam turbine components described herein, such as a valve casing. Centrifugal casting circumvents the need for extensive fabrication by producing the large steam turbine components described herein as single piece or small number of pieces, thereby eliminating or greatly reducing the need for fabrication. In summary, the use of centrifugal casting overcomes the limitations noted above associated with the manufacture large superalloy turbine components, particularly large steam turbine components, with one process and enables the manufacture of improved turbine components using cast superalloy compositions.

In one embodiment, a large volume, cast superalloy pressure containment vessel 10 includes a hollow body portion 16 having a volume of at least about 4 cubic feet and a substantially porosity-free cast microstructure, segregation-free microstructure or fine-grain microstructure, or a combination thereof. The pressure containment vessel 10 is configured for operation at an operating temperature of at least about 1,200° F. and an operating pressure of at least about 1,500 psi. The large volume, cast superalloy pressure containment vessel 10 will have a volume of at least about 4 cubic feet, and more particularly may have a volume of at least about 8 cubic feet, and even more particularly at least about 20 cubic feet, and yet more particularly at least about 30 cubic feet. In the case of a steam turbine nozzle box 200, for example, the casting volume may be at least about 4 cubic feet, and more particularly at least about 8 cubic feet. In the case of a steam turbine shell 106, such as an inner or outer shell, for example, the casting volume may be at least about 4 cubic feet, and more particularly at least about 20 cubic feet, and even more particularly at least about 30 cubic feet. In the case of a steam turbine valve body 300, the casting volume may be at least about 4 cubic feet, and more particularly at least about 15 cubic feet, and even more particularly at least about 25 cubic feet. Thus, in one embodiment, the large volume, cast pressure containment vessels may be described as having a volume of about 4 to about 30 cubic feet, and more particularly about 8 to about 30 cubic feet, and even more particularly about 15 to about 30 cubic feet. In an embodiment, the large volume, cast superalloy article has a volume of at least about 4 cubic feet, a substantially porosity-free cast microstructure, and is configured for operation at an operating temperature of at least about 1,400° F., regardless of the operating pressure at which it is utilized, including atmospheric pressure. That is, the large volume, cast superalloy article configured for operation at an operating temperature of at least about 1,400° F. and lower pressures, including use at atmospheric pressure. In one embodiment, the superalloy casting microstructure, in addition to being a substantially porosity-free microstructure, is also at least one of a substantially segregation-free microstructure or a substantially fine grain microstructure, or a combination thereof.

The large volume, cast superalloy pressure containment vessel 10 comprises a superalloy that is configured for operation, such as substantially-continuous operation of a steam turbine, at a temperature of at least about 1,200° F., and more particularly at least about 1,300° F., and even more particularly up to about 1,500° F. In one embodiment, the large volume, cast superalloy pressure containment vessel 10 includes a superalloy that is configured for operation at an operating temperature of about 1,300° F. to about 1,500° F.

The large volume, cast superalloy pressure containment vessel 10 comprises a superalloy that is configured for operation, such as substantially-continuous operation of a steam turbine, at an operating pressure of at least about 1,500 psi, and more particularly at least about 1,800 psi, and yet more particularly about 3,000 psi, and still more particularly at least about 4,000 psi, and more particularly up to about 6,000 psi. In one embodiment, the large volume, cast superalloy pressure containment vessel 10 includes a superalloy that is configured for operation at an operating pressure of about 4,000 psi to about 6,000 psi.

Referring to FIGS. 1-4, the large volume, cast superalloy pressure containment vessel 10 may include any suitable pressure containment vessel 10, and in one embodiment includes a pressure containment turbine component 6 of a turbine, including a pressure containment steam turbine component of a steam turbine 100. FIG. 1 is a cross-sectional schematic illustration of an exemplary opposed-flow steam turbine 100 engine including a high pressure (HP) section 102 and an intermediate pressure (IP) section 104. A cast large volume superalloy HP shell, or casing, 106 is divided axially into cast large volume superalloy upper half section 108 and cast large volume superalloy lower half section 110, respectively. In the exemplary embodiment, shell 106 and half sections 108 and 110 are inner casings. Alternatively, cast large volume superalloy shell 106 and half sections 108 and 110 are outer casings. A central section 118 positioned between HP section 102 and IP section 104 includes a high pressure steam inlet 120 and an intermediate pressure steam inlet 122. A nozzle box (not shown in FIG. 1) is fluidly coupled between each of high pressure steam inlet 120 and high pressure section 102, and intermediate pressure steam inlet 122 and intermediate pressure section 104.

During operation, high pressure steam inlet 120 receives high pressure/high temperature steam from a steam source, for example, a power boiler (not shown in FIG. 1). Steam flows from high pressure steam inlet 120 through a first nozzle box (not shown in FIG. 1), through an inlet nozzle 136, and through HP section 102, wherein work is extracted from the steam to rotate a rotor shaft 140 via a plurality of turbine blades, or buckets (not shown in FIG. 1) that are coupled to shaft 140.

In the exemplary embodiment, steam turbine 100 is an opposed-flow high pressure and intermediate pressure steam turbine combination. Alternatively, the present invention may be used with any individual turbine including, but not being limited to low pressure turbines. In addition, the present invention is not limited to being used with opposed-flow steam turbines, but rather may be used with steam turbine configurations that include, but are not limited to single-flow and double-flow turbine steam turbines.

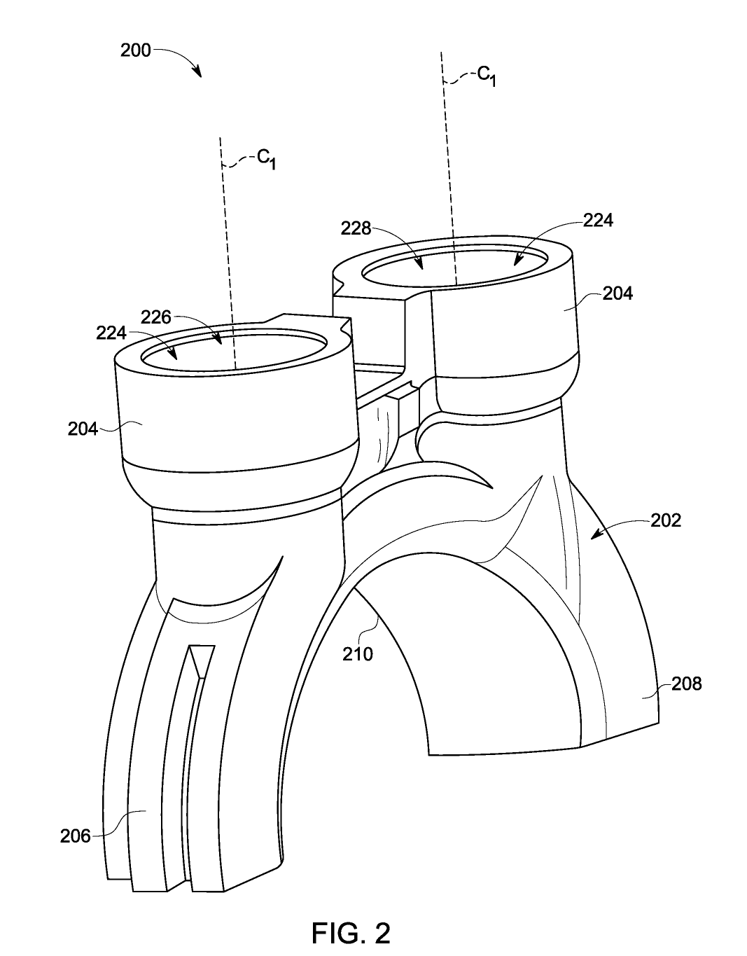

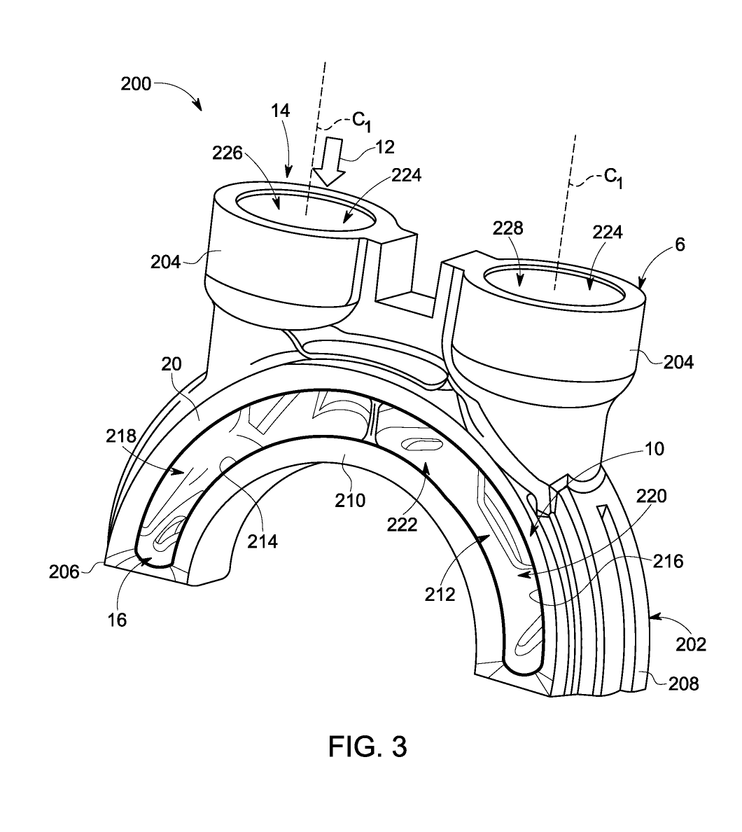

Referring to FIG. 2, in one embodiment, the large volume, cast superalloy pressure containment vessel 10 includes a pressure containment turbine component 6 of a turbine 100 (FIG. 1) in the form of a nozzle box 200 (FIG. 2). FIG. 2 is a perspective view of a cast large volume superalloy steam turbine nozzle box 200 having the casting volumes described herein that may be used with steam turbine engine 100. In the exemplary embodiment, nozzle box 200 includes an annular chamber 202 and two inlets 204 coupled in flow communication with annular chamber 202, wherein each inlet 204 has an axial centerline C₁. Steam turbine nozzle box 200 may be cast from a superalloy as described herein to a net shape, and more particularly, may be cast to a near-net shape and may receive various finishing operations, such as machining, to form the shape shown in FIGS. 2 and 3. FIG. 3 is a partial cross-sectional view of nozzle box 200 and annular chamber 202. In the exemplary embodiment, only a semi-circular half of annular chamber 202 is illustrated, however, cast large volume superalloy steam turbine nozzle box 200 may be cast as an entire annular chamber 202. In the exemplary embodiment, nozzle box 200 includes a vertical centerline C₁ spaced equidistant between each inlet 204. In alternative embodiments, nozzle box 200 may include more or less than two inlets 204.

Annular chamber 202 includes a first section 206, a second section 208, and a center section 210 extending integrally therebetween. In an embodiment having more or less than two inlets 204, annular chamber 202 may include more or less than three sections. Annular chamber 202 also includes a flow path 212 defined by an inner annular wall 214 and an outer annular wall 216 that is radially outward from inner annular wall 214. Flow path 212 includes a flow path first section 218, a flow path second section 220, and a flow path center section 222. Specifically, in the exemplary embodiment, flow path first section 218 is defined within chamber first section 206, flow path second section 220 is defined within chamber second section 208, and flow path center section 222 is defined within chamber center section 210. Furthermore, each inlet 204 includes a flow path 224 formed therethrough that is coupled in flow communication with flow path 212. Specifically, a first inlet flow path 226 is coupled in flow communication with flow path first section 218, and a second inlet flow path 228 is coupled in flow communication with flow path second section 220.

During operation steam, at the operating temperatures and pressures described herein, flows through inlets 204 into annular chamber 202. Specifically, steam is channeled through inlet flow paths 226 and 228 and is discharged into annular chamber 202, wherein steam discharged from inlet flow path 226 enters flow path first section 218, and steam discharged from inlet flow path 228 enters flow path second section 220. Within annular chamber 202 flow path first section 218 and flow path second section 220 are coupled in flow communication with flow path center section 222, such that annular chamber 202 facilitates providing a unitary flow path 212 having an evenly distributed pressure therethrough. Specifically, steam channeled through inlet flow paths 226 and 228 is mixed within annular chamber 202 such that steam discharged from nozzle box 200 has an even temperature and pressure. Steam is discharged from nozzle box 200 through a plurality of nozzles (not shown in FIG. 2) into a first stage of a steam turbine, such as steam turbine 100. The mixture of steam within annular chamber 202 facilitates discharging steam through each of the plurality of nozzles at an equal temperature and pressure. As such, the box provides pressure containment and flow direction within the first stage of the turbine.

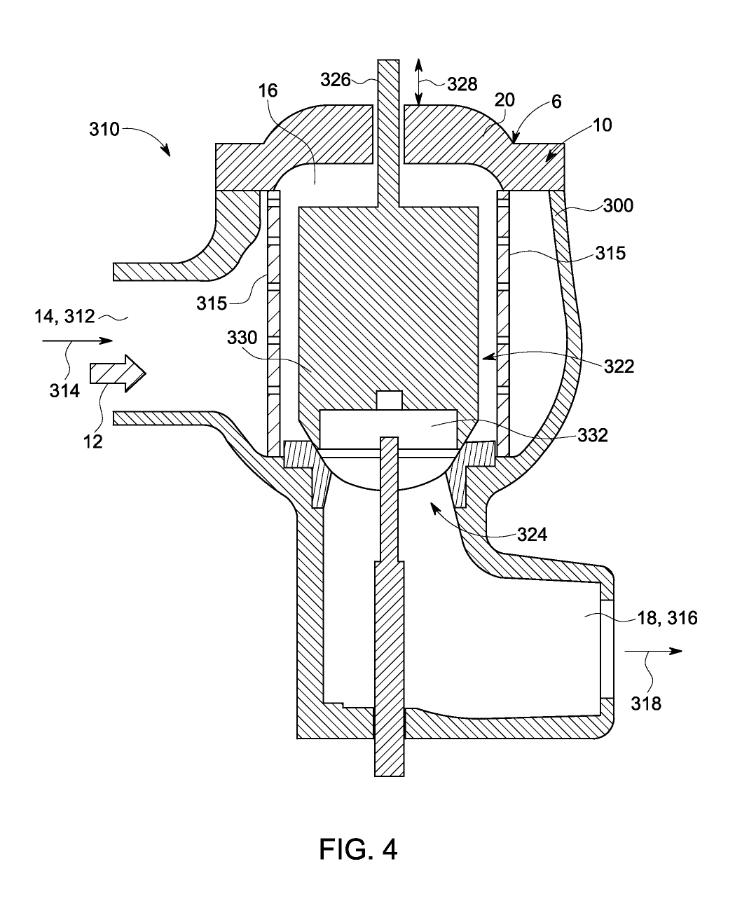

Referring to FIG. 4, in one embodiment, the large volume, cast superalloy pressure containment vessel 10 includes a pressure containment turbine component 6 of a turbine 8 in the form of a valve casing 300 for a steam valve 310. Casing 300 houses the components of a steam valve 310 that is part of a steam turbine. For example, the steam turbine valve 310 may be a combined main stop and control valve, a reheat valve, or other type of steam turbine valve (“flow valve”) that directs the flow of steam entering the flow valve 310 at an inlet 312 (e.g., a pipe), as indicated by a line with an arrowhead 314, then passing through openings in a strainer 315 inside the flow valve 310 and through the flow valve 310, and exiting out of an outlet 316 (e.g., a pipe) of the flow valve 310, as indicated by a line with an arrowhead 318, and on to further components of the steam turbine.

Also housed within a valve casing 300 of the flow valve 310 are a control valve 322 and/or a stop valve 324. The control valve 322 may comprise a cylinder or rod 326 that is configured to be driven in a known manner (e.g., hydraulically, pneumatically, motor-driven, etc.) for, e.g., linear movement as indicated by a line with arrowheads 328. The control valve 322 also includes a valve body 330 located at one end of the rod 326 and connected or formed integral with the rod 326 for simultaneous motion of the control valve body 330 with movement of the rod 326. The control valve body 330 includes a cavity 332 formed in a lower portion of the control valve body 330.

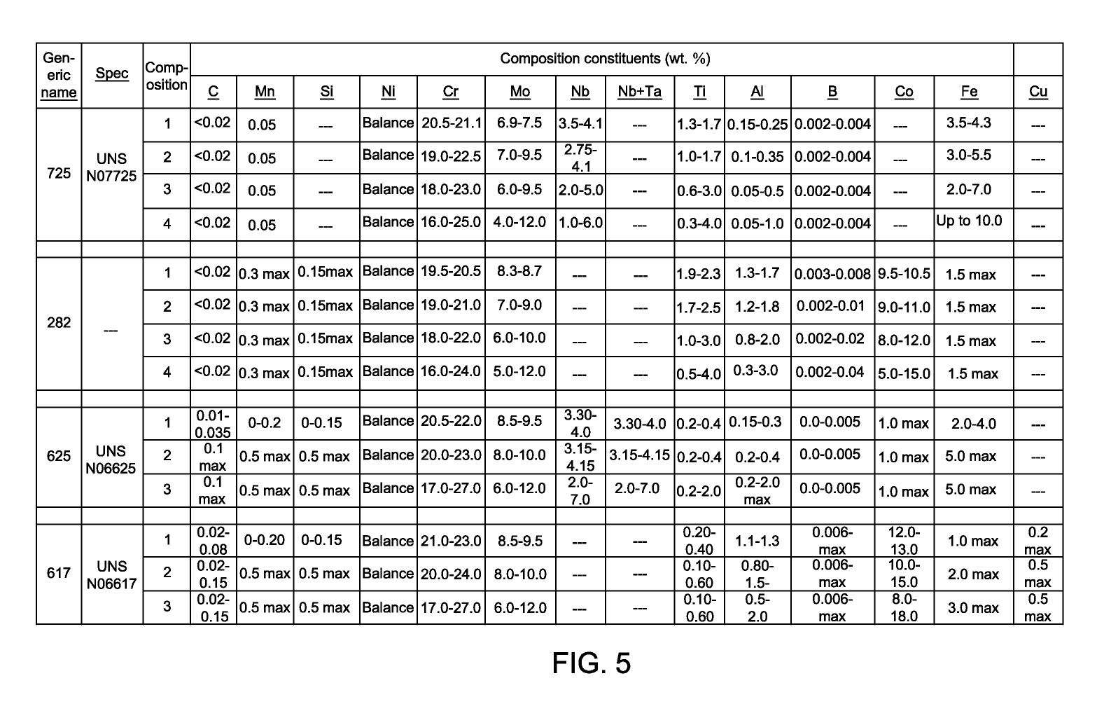

The large volume, cast superalloy pressure containment vessel 10 is formed from a superalloy. Any suitable superalloy may be employed. Suitable superalloys include Ni-base, Co-base or Fe-base superalloy compositions, or a combination thereof. Of these, Ni-base superalloys are particularly useful, including Alloy 625, Alloy 282, Alloy 617 and Alloy 725 alloy compositions, as described in FIG. 5.

In one embodiment, the superalloy composition is an Ni-base superalloy composition that generally encompasses the Alloy 625, Alloy 282 and Alloy 725 alloy compositions, including an alloy composition that comprises, by weight: about 16.0% to about 25.0% Cr, about 5.0% to about 15.0% Co, about 4.0% to about 12.0% Mo, up to about 10.0% Fe, about 1.0% to about 6.0% Nb, about 0.3% to about 4.0% Ti, about 0.05% to about 3.0% Al, about 0.002% to about 0.04% B, up to about 0.30% Mn, up to about 0.15% Si, and less than 0.02% C, with the balance Ni and incidental or trace impurities.

In one embodiment, the superalloy composition is an Ni-base superalloy composition that generally encompasses Alloy 282, including an alloy composition that comprises, by weight: about 16.0% to about 24.0% Cr, about 5.0% to about 15.0% Co, about 5.0% to about 12.0% Mo, up to about 1.5% Fe, about 0.5% to about 4.0% Ti, about 0.30% to about 3.0% Al, about 0.002% to about 0.04% B, up to about 0.30% Mn, up to about 0.15% Si, and less than 0.02% C, with the balance Ni and incidental or trace impurities.

In another embodiment, the superalloy composition is an Ni-base superalloy composition that comprises, by weight: about 19.0% to about 21.0% Cr, about 9.0% to about 11.0% Co, about 7.0% to about 9.0% Mo, up to about 1.5% Fe, about 1.7% to about 2.5% Ti, about 1.2% to about 1.8% Al, about 0.002% to about 0.01% B, up to about 0.30% Mn, up to about 0.15% Si, and less than 0.02% C, with the balance Ni and incidental or trace impurities.

In yet another embodiment, the superalloy composition is an Ni-base superalloy composition that comprises, by weight: about 19.5% to about 20.5% Cr, about 9.5% to about 10.5% Co, about 8.3% to about 8.7% Mo, up to about 1.5% Fe, about 1.9% to about 2.3% Ti, about 1.3% to about 1.7% Al, about 0.003% to about 0.008% B, up to about 0.30% Mn, up to about 0.15% Si, and less than 0.02% C, with the balance Ni and incidental or trace impurities.

In one embodiment, the superalloy composition is an Ni-base superalloy composition that generally encompasses Alloy 725, including an alloy composition that comprises, by weight: about 16.0% to about 25.0% Cr, about 4.0% to about 12.0% Mo, up to about 10.0% Fe, about 1.0% to about 6.0% Nb, about 0.3% to about 4.0% Ti, about 0.05% to about 1.0% Al, about 0.002% to about 0.004% B, up to about 0.05% Mn, and less than 0.02% C, with the balance Ni and incidental or trace impurities.

In one embodiment, the superalloy composition is an Ni-base superalloy composition that generally encompasses Alloy 625, including an alloy composition that comprises, by weight: about 17.0 to about 27.0% Cr, about 6.0% to about 12.0% Mo, about 2.0% to about 7.0% of Nb or Ta, or a combination thereof, about 0.2% to about 2.0% Ti, about 0.2% to about 2.0% Al, up to about 5% Fe, up to about 1.0% Co, up to about 0.5% Mn, up to about 0.5% Si, up to about 0.1% C, up to about 0.005% B with the balance Ni and incidental or trace impurities.

In another embodiment, the superalloy composition is an Ni-base superalloy composition that comprises, by weight: about 20.0% to about 23.0% Cr, about 8.0% to about 10.0% Mo, about 3.15% to about 4.15% of Nb or Ta, or a combination thereof, about 0.2% to about 0.4% Ti, about 0.2% to about 0.4% Al, up to about 5% Fe, up to about 1.0% Co, up to about 0.5% Mn, up to about 0.5% Si, up to about 0.1% C, up to about 0.005% B with the balance Ni and incidental or trace impurities.

In yet another embodiment, the superalloy composition is an Ni-base superalloy composition that comprises, by weight: about 20.5% to about 22.0% Cr, about 8.5% to about 9.5% Mo, about 3.30% to about 4.0% of Nb or Ta, or a combination thereof, about 0.2% to about 0.4% Ti, about 0.15% to about 0.30% Al, about 2.0% to about 4.0% Fe, up to about 1.0% Co, up to about 0.2% Mn, up to about 0.15% Si, about 0.01% to about 0.035% C, up to about 0.005% B with the balance Ni and incidental or trace impurities.

In one embodiment, the superalloy composition is an Ni-base superalloy composition that generally encompasses Alloy 617, including an alloy composition that comprises, by weight: about 17.0 to about 27.0% Cr, about 8.0% to about 18.0% Co, about 6.0 to about 12.0% Mo, about 0.1 to about 0.6% Ti, about 0.5 to about 2.0% Al, up to about 3% Fe, up to about 0.6% Mn, up to about 0.6% Si, about 0.02% to about 0.15% C, up to about 0.5% Cu, up to about 0.006% B with the balance Ni and incidental or trace impurities.

In another embodiment, the superalloy composition is an Ni-base superalloy composition that comprises, by weight: about 20.0 to about 24.0% Cr, about 10.0% to about 15.0% Co, about 8.0 to about 10.0% Mo, about 0.1 to about 0.6% Ti, about 0.8% to about 1.5% Al, up to about 2% Fe, up to about 0.5% Mn, up to about 0.5% Si, about 0.02% to about 0.15% C, up to about 0.5% Cu, up to about 0.006% B with the balance Ni and incidental or trace impurities.

In yet another embodiment, the superalloy composition is an Ni-base superalloy composition that comprises, by weight: about 21.0 to about 23.0% Cr, about 12.0% to about 13.0% Co, about 8.5 to about 9.5% Mo, about 0.2 to about 0.4% Ti, about 1.1% to about 1.3% Al, up to about 1% Fe, up to about 0.20% Mn, up to about 0.15% Si, about 0.02% to about 0.08% C, up to about 0.2% Cu, up to about 0.006% B with the balance Ni and incidental or trace impurities.

The use of centrifugal casting will enable the achievement of cast large volume superalloy articles that have a smaller grain size than would be achievable using conventional casting methods and significantly contributes to the usefulness of these articles. For example, centrifugal casting may be used to achieve an ASTM grain size of about 4 in these articles which provides physical and mechanical properties suitable for use in advanced ultra-critical steam turbine applications, for example, in contrast to an ASTM grain size of about 00 that is achievable using conventional casting methods, which provides physical and mechanical properties that may not be suitable for use in advanced ultra-critical steam turbine applications. Stated differently, centrifugal casting provides a reduction in grain size of the superalloys disclosed herein of about 4-6 ASTM grain size numbers. This reduction benefits fatigue behavior.

The cast large volume superalloy articles disclosed herein will enable the development of advanced ultra-super critical steam turbines. Ultra super critical steam turbines presently utilize inlet steam conditions of about 1,150° F. and 3770 psi. Use of the cast large volume superalloy articles disclosed herein will enable higher inlet steam conditions of at least about 1,200° F. and an operating pressure of at least about 1,500 psi, as described herein.

The terms “a” and “an” herein do not denote a limitation of quantity, but rather denote the presence of at least one of the referenced items. The modifier “about” used in connection with a quantity is inclusive of the stated value and has the meaning dictated by the context (e.g., includes the degree of error associated with measurement of the particular quantity). Furthermore, unless otherwise limited all ranges disclosed herein are inclusive and combinable (e.g., ranges of “up to about 25 weight percent (wt. %), more particularly about 5 wt. % to about 20 wt. % and even more particularly about 10 wt. % to about 15 wt. %” are inclusive of the endpoints and all intermediate values of the ranges, e.g., “about 5 wt. % to about 25 wt. %, about 5 wt. % to about 15 wt. %”, etc.). The use of “about” in conjunction with a listing of constituents of an alloy composition is applied to all of the listed constituents, and in conjunction with a range to both endpoints of the range. Finally, unless defined otherwise, technical and scientific terms used herein have the same meaning as is commonly understood by one of skill in the art to which this invention belongs. The suffix “(s)” as used herein is intended to include both the singular and the plural of the term that it modifies, thereby including one or more of that term (e.g., the metal(s) includes one or more metals). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments.

It is to be understood that the use of “comprising” in conjunction with the alloy compositions described herein specifically discloses and includes the embodiments wherein the alloy compositions “consist essentially of” the named components (i.e., contain the named components and no other components that significantly adversely affect the basic and novel features disclosed), and embodiments wherein the alloy compositions “consist of” the named components (i.e., contain only the named components except for contaminants which are naturally and inevitably present in each of the named components).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A large volume, cast superalloy pressure containment vessel comprising a hollow body portion having a volume of at least about 4 cubic feet and a substantially porosity-free cast microstructure, the containment vessel configured for operation at an operating temperature of at least about 1,200° F. and an operating pressure of at least about 1,500 psi.

2. The containment vessel of claim 1, wherein the superalloy is configured for operation at an operating temperature of about 1,300° F. to about 1,500° F.

3. The containment vessel of claim 1, wherein the high operating temperature alloy is configured for operation at an operating pressure of at least about 3,000 psi.

4. The containment vessel of claim 3, wherein the high operating temperature alloy is configured for operation at an operating pressure of about 4,000 psi to about 6,000 psi.

5. The containment vessel of claim 1, wherein the containment vessel comprises a turbine component.

6. The containment vessel of claim 5, wherein the turbine component comprises a steam turbine component.

7. The containment vessel of claim 6, wherein the steam turbine component comprises a turbine shell.

8. The containment vessel of claim 6, wherein the steam turbine component comprises a nozzle box.

9. The containment vessel of claim 6, wherein the steam turbine component comprises a valve casing.

10. The containment vessel of claim 1, wherein the superalloy composition comprises an Ni-base, Co-base or Fe-base superalloy composition, or a combination thereof.

11. The containment vessel of claim 10, wherein the Ni-base superalloy composition comprises, by weight: about 16.0 to about 25.0% Cr, about 5.0 to about 15.0% Co, about 4.0 to about 12.0% Mo, up to about 10.0% Fe, about 1.0 to about 6.0% Nb, about 0.3 to about 4.0% Ti, about 0.05 to about 3.0% Al, about 0.002 to about 0.04% B, up to about 0.30% Mn, up to about 0.15% Si, and less than 0.02% C, with the balance Ni and incidental or trace impurities.

12. The containment vessel of claim 10, wherein the Ni-base superalloy composition comprises, by weight: about 16.0 to about 24.0% Cr, about 5.0 to about 15.0% Co, about 5.0 to about 12.0% Mo, up to about 1.5% Fe, about 0.5 to about 4.0% Ti, about 0.30 to about 3.0% Al, about 0.002 to about 0.04% B, up to about 0.30% Mn, up to about 0.15% Si, and less than 0.02% C, with the balance Ni and incidental or trace impurities.

13. The containment vessel of claim 12, wherein the Ni-base superalloy composition comprises, by weight: about 19.0 to about 21.0% Cr, about 9.0 to about 11.0% Co, about 7.0 to about 9.0% Mo, up to about 1.5% Fe, about 1.7 to about 2.5% Ti, about 1.2 to about 1.8% Al, about 0.002 to about 0.01% B, up to about 0.30% Mn, up to about 0.15% Si, and less than 0.02% C, with the balance Ni and incidental or trace impurities.

14. The containment vessel of claim 12, wherein the Ni-base superalloy composition comprises, by weight: about 19.5 to about 20.5% Cr, about 9.5 to about 10.5% Co, about 8.3 to about 8.7% Mo, up to about 1.5% Fe, about 1.9 to about 2.3% Ti, about 1.3 to about 1.7% Al, about 0.003 to about 0.008% B, up to about 0.30% Mn, up to about 0.15% Si, and less than 0.02% C, with the balance Ni and incidental or trace impurities.

15. The containment vessel of claim 10, wherein the Ni-base superalloy composition comprises, by weight: about 16.0 to about 25.0% Cr, about 4.0 to about 12.0% Mo, up to about 10.0% Fe, about 1.0 to about 6.0% Nb, about 0.3 to about 4.0% Ti, about 0.05 to about 1.0% Al, about 0.002 to about 0.004% B, up to about 0.05% Mn, and less than 0.02% C, with the balance Ni and incidental or trace impurities.

16. The containment vessel of claim 10, wherein the Ni-base superalloy composition comprises, by weight: about 17.0 to about 27.0% Cr, about 6.0 to about 12.0% Mo, about 2.0 to about 7.0% of Nb or Ta, or a combination thereof, about 0.2 to about 2.0% Ti, about 0.2 to about 2.0% Al, up to about 5% Fe, up to about 1.0% Co, up to about 0.5% Mn, up to about 0.5% Si, up to about 0.1% C, up to about 0.005% B with the balance Ni and incidental or trace impurities.

17. The containment vessel of claim 16, wherein the Ni-base superalloy composition comprises, by weight: about 20.0 to about 23.0% Cr, about 8.0 to about 10.0% Mo, about 3.15 to about 4.15 of Nb or Ta, or a combination thereof, about 0.2 to about 0.4% Ti, about 0.2 to about 0.4% Al, up to about 5% Fe, up to about 1.0% Co, up to about 0.5% Mn, up to about 0.5% Si, up to about 0.1% C, up to about 0.005% B with the balance Ni and incidental or trace impurities.

18. The containment vessel of claim 16, wherein the Ni-base superalloy composition comprises, by weight: about 20.5 to about 22.0% Cr, about 8.5 to about 9.5% Mo, about 3.30 to about 4.0 of Nb or Ta, or a combination thereof, about 0.2 to about 0.4% Ti, about 0.15 to about 0.30% Al, about 2.0 to about 4.0% Fe, up to about 1.0% Co, up to about 0.2% Mn, up to about 0.15% Si, about 0.01 to about 0.035% C, up to about 0.005% B with the balance Ni and incidental or trace impurities.

19. The containment vessel of claim 10, wherein the Ni-base superalloy composition comprises, by weight: about 17.0 to about 27.0% Cr, about 8.0% to about 18.0% Co, about 6.0 to about 12.0% Mo, about 0.1 to about 0.6% Ti, about 0.5 to about 2.0% Al, up to about 3% Fe, up to about 0.6% Mn, up to about 0.6% Si, up to about 0.5% Cu, about 0.02% to about 0.15% C, up to about 0.006% B with the balance Ni and incidental or trace impurities.

20. The containment vessel of claim 1, wherein the cast microstructure further comprises at least one of a substantially segregation-free microstructure or a substantially fine grain microstructure, or a combination thereof.

21. A large volume, cast superalloy article having a volume of at least about 4 cubic feet and a substantially porosity-free cast microstructure, the article configured for operation at an operating temperature of at least about 1,400° F.

22. A large volume, cast superalloy pressure containment vessel comprising a hollow body portion and a substantially porosity-free cast microstructure.

23. The pressure containment vessel of claim 22, wherein the vessel comprises a component of a steam turbine.

24. The pressure containment vessel of claim 22, wherein the vessel has a volume of the superalloy of at least about 4 cubic feet or is configured for operation at an operating temperature of at least about 1,200° F. or at an operating pressure of at least about 1,500 psi, or any combination of the foregoing.
